(19) United States
(12) Patent Application Publication
(10) Pub. No.: US 2022/0146655 A1
(43) Pub. Date: May 12, 2022

(54) SYSTEM AND METHOD

(71) Applicant: KABUSHIKI KAISHA TOSHIBA, Tokyo (JP)

(72) Inventors: Yutaka ASANUMA, Bunkyo Tokyo (JP); Hiroki MORI, Kawasaki Kanagawa (JP)

(73) Assignee: KABUSHIKI KAISHA TOSHIBA, Tokyo (JP)

(21) Appl. No.: 17/467,577

(22) Filed: Sep. 7, 2021

(30) Foreign Application Priority Data
Nov. 9, 2020 (JP) 2020-186625

(51) Int. Cl. G01S 13/04; G01S 7/06; G01S 13/32; G01S 13/46

(52) U.S. Cl. CPC G01S 13/04; G01S 7/06; G01S 2013/0254; G01S 13/46; G01S 13/32

(57) ABSTRACT

According to one embodiment, a system includes a radar and a controller. The radar includes at least one first antenna and at least one second antenna. The at least one first antenna transmits a first transmission wave at a first time and transmits a second transmission wave at a second time different from the first time. The at least one second antenna receives reflected waves of the first transmission wave and the second transmission wave.

### CROSS-REFERENCE TO RELATED APPLICATIONS

This application is based upon and claims the benefit of priority from Japanese Patent Applications No. 2020-186625, filed Nov. 9, 2020, the entire contents of which are incorporated herein by reference.

### FIELD

Embodiments described herein relate generally to a system and method.

### BACKGROUND

In an electric facility such as an electric power substation or the like, at the time of an inspection, construction or the like, the supply of electricity is stopped. At this time, for confirmation of safety, work for confirming that the supply of electricity is really cut off is carried out. In the case of a high-voltage facility, a voltage detector or current detector installed at a tip of an insulating rod is made close to a conductor such as an electric wire or the like, whereby confirmation of the electric-power shutdown is carried out.

However, because of the work of making a long rod close to the electric wire, an elongated instrument is required and, the work itself requires safety confirmation and thus has been troublesome work. For this reason, a voltage detecting method and current detecting method requiring no accession to the electric wire have been desired.

Because of such a situation, as a noncontact voltage detecting method requiring no accession to the electric wire, a method or the like which utilizes reflection of a beam of light such as laser light to detect vibration of the electric wire, thereby voltage detection is proposed. However, under the existing circumstances, voltage detection using the insulating rod and voltage detector is carried out in an ongoing manner. As the reason why the device of the voltage detecting method utilizing reflection of a beam of light is not used, cost, difficulty in usage, and the like are conceivable. Regarding the difficulty in usage, that it is necessary to accurately apply laser light to an objective electric wire or wire group, and hence the work of setting the device in a stable state by using a tripod or the like, and adjusting the radiation direction of laser light to the electric wire is required can be pointed out. Accordingly, a lot of troublesomeness hindered the method from becoming an alternative means or auxiliary means of the voltage detection using the insulating rod and voltage detector.

As described above, in the noncontact voltage detection using, for example, laser light, there has been problems in the usability, such as setting of the device, selection of the object of voltage detection, and the like.

### BRIEF DESCRIPTION OF THE DRAWINGS

FIG. 1 is a block diagram showing an example of a functional configuration of a system of an embodiment.

FIG. 2 is a diagram for explaining a mechanism for measuring a distance to the object by using an FMCW radar using the chirp.

FIG. 3 is a diagram showing an example of a form of display for directing the radar to the object in the system of the embodiment.

FIG. 4 is a diagram showing an example of display of a result of detection of an object in the system of the embodiment.

FIG. 5 is a diagram showing an example of comparison between an output of Range-FFT and result of extracting only the predetermined frequency component from an output of Slow-FFT.

FIG. 6 is a diagram showing an example of a case where the system of the embodiment obtains a distance to an object for each antenna to thereby carry out position estimations of a plurality of objects.

FIG. 7 is a flowchart showing an example of a processing procedure of the system of the embodiment.

FIG. 8 is a diagram showing an example of the hardware configuration of the system of the embodiment.

FIG. 9 is a diagram showing another example of the hardware configuration of the system of the embodiment.

FIG. 10 is a diagram showing still another example of the hardware configuration of the system of the embodiment.

### DETAILED DESCRIPTION

Embodiments will be described hereinafter with reference to the accompanying drawings.

In general, according to one embodiment, a system includes a radar and a controller. The radar includes at least one first antenna and at least one second antenna. The at least one first antenna transmits a first transmission wave at a first time and transmits a second transmission wave at a second time different from the first time. The at least one second antenna receives reflected waves of the first transmission wave and the second transmission wave.

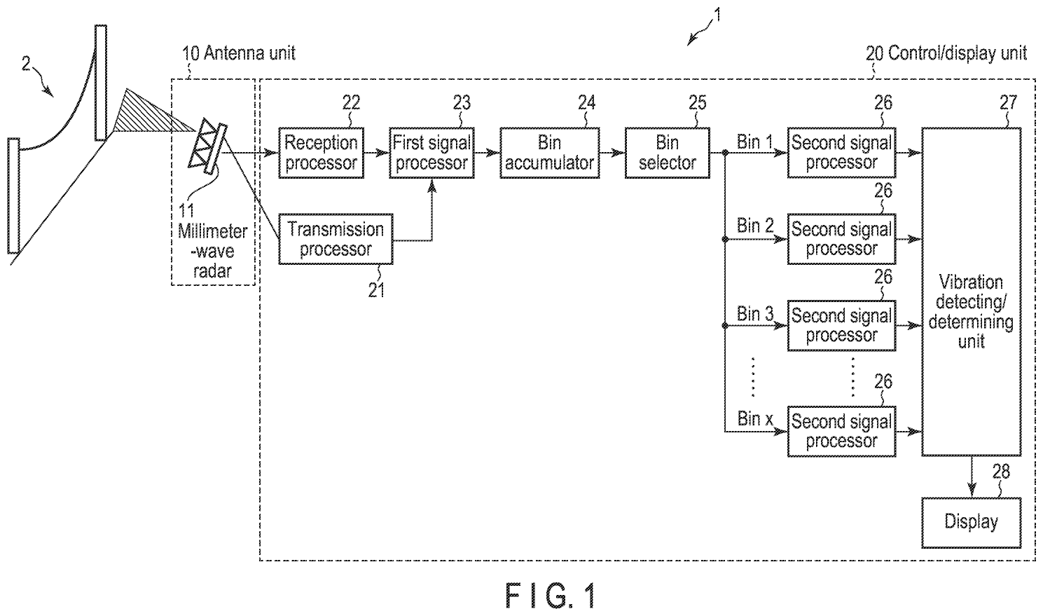

FIG. 1 is a block diagram showing an example of a functional configuration of a system 1 of the embodiment. The system 1 of this embodiment is a noncontact voltage defecting system and includes an antenna unit 10 and a control/display unit 20.

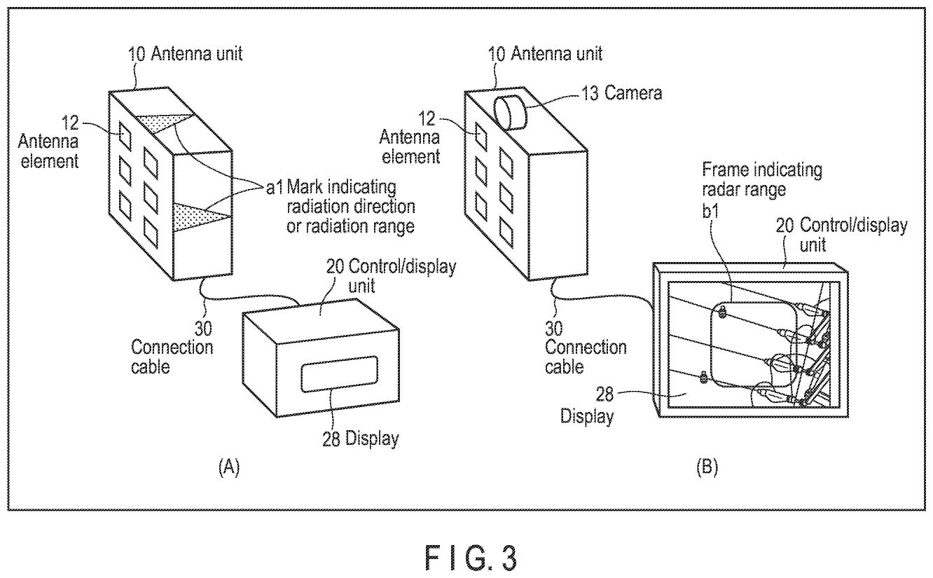

In the system 1 of this embodiment, a radar configured to radiate an electric wave toward an object (electric wire 2) to be measured and receive the reflected wave is used. The antenna unit 10 includes a millimeter-wave radar 11. In the antenna unit 10, a plurality of antenna elements 12 (see FIG. 3) are provided.

The radar obtains a distance by measuring a temporal difference between transmission and reception. The millimeter-wave radar 11 using the 60 GHz band or 76 GHz band can legally use a wide bandwidth of 1 GHz or more, and hence is used as a frequency modulated continuous wave (FMCW) radar. As the frequency-modulated wave, in particular, the chirp in which the frequency monotonically increases (or decreases) is used.

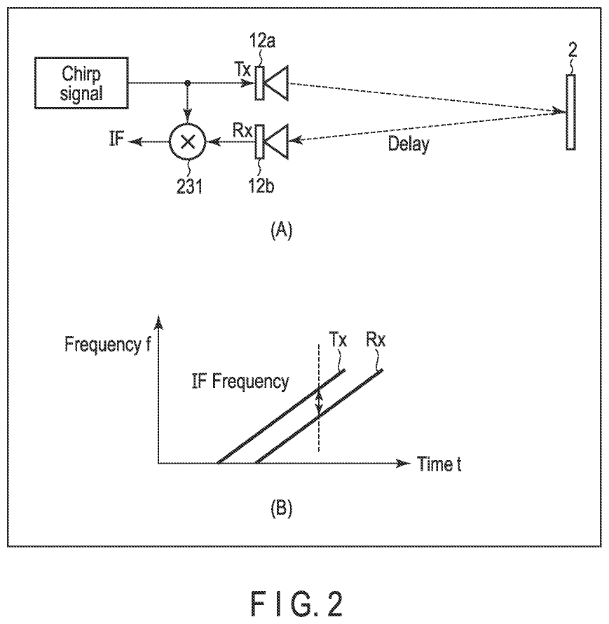

FIG. 2 is a diagram for explaining a mechanism for measuring a distance to the object by using the FMCW radar using the chirp.

As shown in FIG. 2(A), the FMCW radar transmits a signal by using a transmitting antenna 12a. Then, the FMCW radar receives the signal which is the transmitted signal reflected from the object by using a receiving antenna 12b. In the case of the FMCW radar in which the chirp is used, frequency detection of the received signal is carried out by using the transmission signal. More specifically, the transmission signal and received signal are mixed with each other by a mixer 231, whereby an intermediate-frequency (IF) signal is created. The transmitting antenna 12a and receiving antenna 12b are generically called antennas 12 or antenna elements 12 in some cases.

The received signal is a signal transmitted the time corresponding to going to and back from the object ago, and hence there is a frequency difference between the frequency of received signal and frequency of the signal currently transmitted, i.e., frequency used for detection. Accordingly, as shown in FIG. 2(B), a frequency difference is caused between the detected outputs (IF signals). This frequency difference corresponds to the temporal difference between transmission and reception, i.e., the distance. Accordingly, the distance to the object can be measured based on the frequency of the IF signal.

Returning to FIG. 1, the description of the functional configuration of the system 1 of this embodiment will be continued.

The control/display unit 20 includes a transmission processor 21, a reception processor 22, a first signal processor 23, Bin accumulator 24, and Bin selector 25. Further, the control/display unit 20 includes a plurality of second signal processors 26, a vibration detecting/determining unit 27, and a display 28. Each of the units (21 to 27) of the control/display unit 20 may be realized by hardware (electrical circuits) or may be realized by the processor (not shown) in the control/display unit 20 by executing programs.

The transmission processor 21 creates a chirp signal the frequency of which monotonically increases (or decreases) by using, for example, a synthesizer, and transmits a transmission wave corresponding to the chirp signal by using the antenna unit 10. The reception processor 22 outputs the signal of the reception wave received by the antenna unit 10 as the reflected wave of the transmission wave transmitted by the antenna unit 10.

The first signal processor 23 mixes the signal of the reception wave output from the reception processor 22 and latest chirp signal (signal of the transmission wave) created by the transmission processor 21 with each other to thereby create IF signals, and separates the IF signals from each other for each frequency. That is, the mixer 231 in FIG. 2(A) is, in the system 1 of this embodiment, provided in the first signal processor 23.

When the transmission wave of the millimeter-wave radar is reflected from a plurality of objects at different distances, by separating the IF signals from each other for each frequency, it is possible to easily obtain received signals separated from each other for each distance. There are various methods for acquiring a signal for each frequency, in the system 1 of this embodiment, signals for the individual frequencies are obtained by using fast Fourier transformation (FFT). This processing is called Range-FFT. Further, the signal for each frequency is called a Range-Bin or Bin. By using a plurality of chirp signals to be transmitted at different transmission times, it is possible to detect the vibration of the electric wire 2 which is the object by a change in the signal of the Bin indicating the frequency corresponding to the distance at which the object exists.

The Bin accumulator 24 accumulates signals for the individual frequencies, i.e., the Bins acquired by the first signal processor 23 to the number corresponding to at least two generations. The expression “the Bins of the number corresponding to two generations” implies, when the chirp signals are created/transmitted at intervals of the time Tc, both the Bin concerning the latest chirp signal, and Bin concerning the chirp signal one signal before, i.e., Bin concerning the chirp signal the time Tc ago.

When parameters concerning detection of the electric wire 2 are input, the Bin selector 25 selects Bins coincident with the parameters from the Bins accumulated in the Bin accumulator 24 and supplies the selected Bins one by one and separately to the individual second signal processors 26. Parameters that can be input to the Bin selector 25 will be described later. When no parameters are input thereto, the Bin selector 25 selects all the Bins and supplies the Bins one by one and separately to the individual second signal processors 26. When the second signal processors 26 fire realized by the program, each of the second signal processors 26 may have a multitasking function.

The second signal processor 26 subjects the signal for each Bin supplied from the Bin selector 25 to FFT to thereby obtain the frequency spectrum and acquire the frequency components of the vibration occurring to the electric wire 2 in the case where the electric wire 2 is in the energized state. This FFT is called Slow-FFT.

The vibration detecting/determining unit 27 determines whether or not the predetermined frequency component (frequency component of vibration occurring to the electric wire 2 in the case where the electric wire 2 is in the energized state) to be acquired by each of the plurality of second signal processors 26 is greater than or equal to a threshold. When the frequency component greater than or equal to the threshold is acquired, the vibration detecting/determining unit 27 determines that an electric wire 2 in the energized state exists at a distance corresponding to the frequency of the Bin to be processed by the second signal processor 26 concerned. The vibration detecting/determining unit 27 displays information indicating presence/absence of detection of the electric wire 2 in the energized state and information and the like indicating the position at which the detected electric wire 2 in the energized state exists on the display 23.

The electric wave propagates from the antenna 12 while spreading cut in a conical shape. Although the angle (directivity) of spreading out in the conical shape can be set by the configuration of the antenna 12, the characteristics that the electric wave propagates while spreading out in the conical shape stay constant. Accordingly, as compared with the laser light which linearly propagates while hardly spreading out, the electric wave can reach a wider range of area and makes it possible to receive reflected waves from objects in the wide range of area. The radar 11 of this embodiment includes a plurality of transmitting antennas 12a or a plurality of receiving antennas 12b in order to set directivity. Each of the antennas 12 may have directivity different from any other antennas 12. Alternatively, by processing signals of a plurality of antennas 12 and using the antennas 12 as the phased array antenna, the radar 11 acquires electrically controllable directivity. Accordingly, by only directing the radar 11 to the direction of the electric wire in a rough way or by only electrically controlling the directivity of the radar 11 in addition to roughly directing the radar 11 to the electric wire, it is possible to select the electric wire existing in that direction as the object of voltage detection and detect vibration of the electric wire in the energized state.

FIG. 3 is a diagram showing an example of a form of display for directing the radar 11 to the object.

In a first example shown in FIG. 3(A), marks a1 indicating the direction of radiation or range of radiation are attached to the peripheral walls of the housing of the antenna unit 10 in which the antenna elements 12 of the radar 11 are provided. By directing the antenna unit 10 to the object while using the marks a1 as a guideline, it is possible to make the object included in the measurement range. Here, an example in which the antenna unit 10 and control/display unit 20 are physically separated from each other and are connected to each other with a connection cable 30 is shown, these units 10 end 20 may also be accommodated it the same housing. The control/display unit 20 displays a message or the like indicating presence/absence of detection of an electric wire 2 in the energized state on the display 28. Further, the control/display unit 20 may make presence/absence of the detection recognizable by a method other than the method based on the sense of sight such as outputting of a warning sound, causing vibration, and like.

In a second example shown in FIG. 3(B), a camera 13 is provided on the antenna unit 10. The camera 13 is provided on the antenna unit 10 such that the radiation direction of the radar 11 and shooting direction of the camera 13 are coincident with each other. The control/display unit 20 displays the image of the camera 13 on the display 28, and indicates a frame-like mark b1 indicative of the radiation range of the radar 11 on the image. By making the object included in the range of the frame-like mark b1, it is possible to make the object included in the measurement range. The range of the image displayed on the display 28 may be made the measurement range. That is, indicating the frame-like mark b1 on the image is not indispensable.

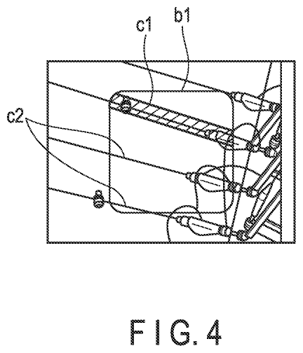

The control/display unit 20 displays the detection result on the electric wire inside the image or the camera 13 in a superposing manner as shown in, for example, FIG. 4. FIG. 4 is an example of an image of the camera 13 displayed on the display 28, and the electric wire indicated by a symbol c1 inside the frame-like mark b1 is the electric wire in the energized state. The electric wires indicated by a symbol c2 are non-energized electric wires. When the detection result is displayed on the electric wire inside the image of the camera 13 in a superposing manner, in the case of a measurement result of high reliability, the measurement result may be depicted in a strong tone such as a deep color, thick line, solid line, filling, and the like and, in the case of a questionable measurement result, the measurement result may be depicted in a vague tone such as a light color, thin line, dotted line, shading, and the like. Further, the frame may be made duplicate, the range inside the inner frame may be made the measurement range, range between the inner frame and outer frame may be made the reference measurement range and, when an electric wire in the energized state is detected within the reference measurement range, the display of the detection result within the range between the inner frame and outer frame may be changed to the display of the detection result within the range inside the inner frame by moving the radar 11, i.e., by moving the antenna unit 10 and thereby moving the image of the electric wire of the object to the inside of the inner frame in such a manner as to prompt the measurement to be carried out. In order to position the electric wire which is the object to be measured at the center of the inner frame, a mark indicating the center of the measurement range may be attached to the display.

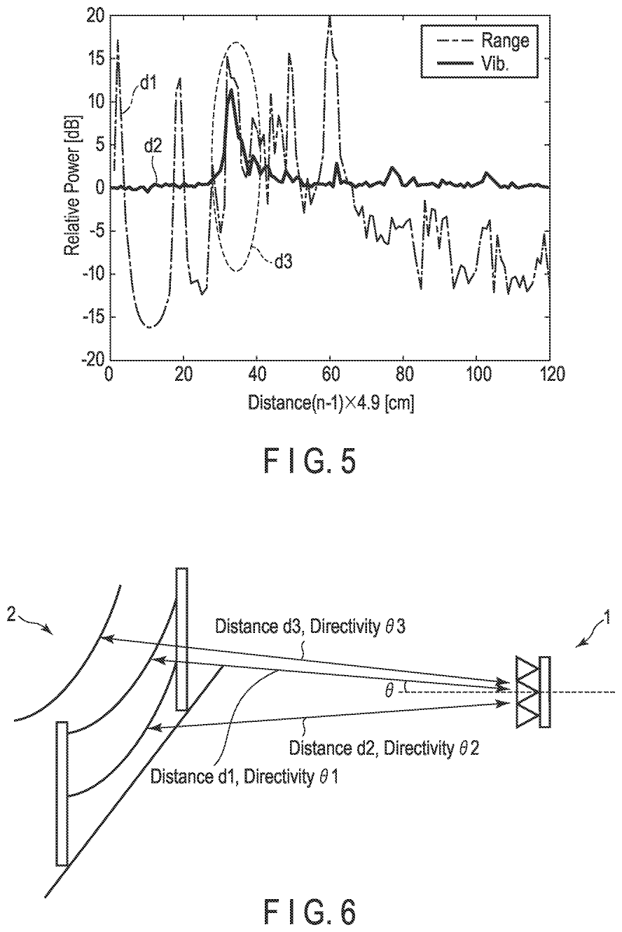

When a pole, beam, and non-energized electric wire exist around the electric wire in the energized state, reflected waves from them are also received. In order to carry out voltage detection, it is necessary to detect only the vibrating electric wire. For that purpose, it is sufficient if only an object vibrating at a predetermined frequency is selected. In the system 1 of this embodiment, it is possible to extract only the predetermined frequency component from the frequency spectrum of the output of Slow-FFT described previously. FIG. 5 is a diagram showing an example of comparison between an output of Range-FFT and result of extracting only the predetermined frequency component (100 Hz component) from the output of Slow-FFT. The output (d1) of Range-FFT is the output of the FMCW radar in which the normal chirp is used, and a large number of reflected waves other than the reflected wave from the electric wire in the energized state are observed. Conversely, in the result (d2) of extracting only the predetermined frequency component (100 Hz component) from the output of Slow-FFT which is the output in the system 1 of this embodiment, there is one large response (d3), and only the Bin corresponding to the distance to the electric wire in the energized state and vibrating at the predetermined frequency (100 Hz) is detected.

In the system 1 of this embodiment, unless the frequency of vibration is already known, it is not possible to detect the Bin corresponding to the distance at which the electric wire in the energized state exists, and hence the frequency of vibration is set in advance. Alternatively, the frequency of the AC voltage (current) of the object to be measured and frequency of the vibration thereof are correspondent to each other, and hence the frequency of the AC power may also be set. It may be made possible to input the set contents to the second signal processor 26 as a parameter. That is, it may be made possible to change the frequency of vibration of the measuring object.

In the above description, in order to detect the frequency of vibration, the second signal processor 26 uses Slow-FFT, i.e., Fourier transformation to thereby obtain the frequency spectrum. However, the second signal processor 26 need not obtain the frequency spectrum of a wide frequency band and, it is sufficient if the second signal processor 26 detects presence/absence of the predetermined frequency component. When the predetermined frequency component is to be obtained, correlation, band-pass filtering, frequency detection, resonance, and the like can also be used.

Further, when the range of the distance to be measured is specified in advance, it becomes possible to reduce the number of Bins to be determined, reduce the throughput, and improve the detection accuracy. For example, when Bins are set at intervals of 5 cm, in the distance of 10 m, 200 Bins exist. Here, if the distance is roughly set within a range from 5 m to 7 m by visual measurement or the like, it becomes sufficient if only 40 Bins are processed. It is possible to input the set contents to the Bin selector 25 as parameters. The Bin selector 25 selects only Bins coincident with the input parameters from among the Bins accumulated in the Bin accumulator 24. The measurement range may be set by manipulating the frame-like mark b1 indicating the radiation range and displayed on the image of the camera in a superposing manner. The set contents change the electrically-controllable directivity, and make the radiation range to be displayed and directivity of the radar coincident with each other.

Further, in the above description, an example in which the position of the electric wire in the energized state is identified by the directivity of the radar 11 is shown. In place of the above, it is also allowable to carry out Range-FFT and Slow-FFT for each of the antennas 12 to thereby obtain the distance to the electric wire 2 in the energized state for each of the antennas 12. It is possible to carry out position estimations of a plurality of electric wires in the energized state based on the antenna directivity and distance between the antenna and electric wire as shown in FIG. 6. With respect to the electric wire caught by the Slow-FFT, the angle θ is detected by the directivity of the radar 11, and distance d is calculated based on the Bin of the Range-FFT, whereby the position is estimated. When a plurality of transmitting antennas and a plurality of receiving antennas are provided, it is possible to carry out a stricter position estimation by the MIMO radar technique.

Further, even when there are a plurality of electric wires in the energized state within the measurement range, it is possible to detect these electric wires independent of each other based on the antenna directivity or selection of the Bin or the Range-FFT, i.e., the distance. When there are a plurality of detection results, the existence of the results are simultaneously displayed on the screen on which the measurement result is to be displayed. When the detection results are displayed on the electric wires of the camera image in a superposing manner, each of the detection results is displayed on each of the plurality of electric wires in the energized state in a superposing manner. Even when energization of one of three electric wires of three-phase AC is stopped due to disconnection or the like, it is possible to observe the two electric wires in the energized state.

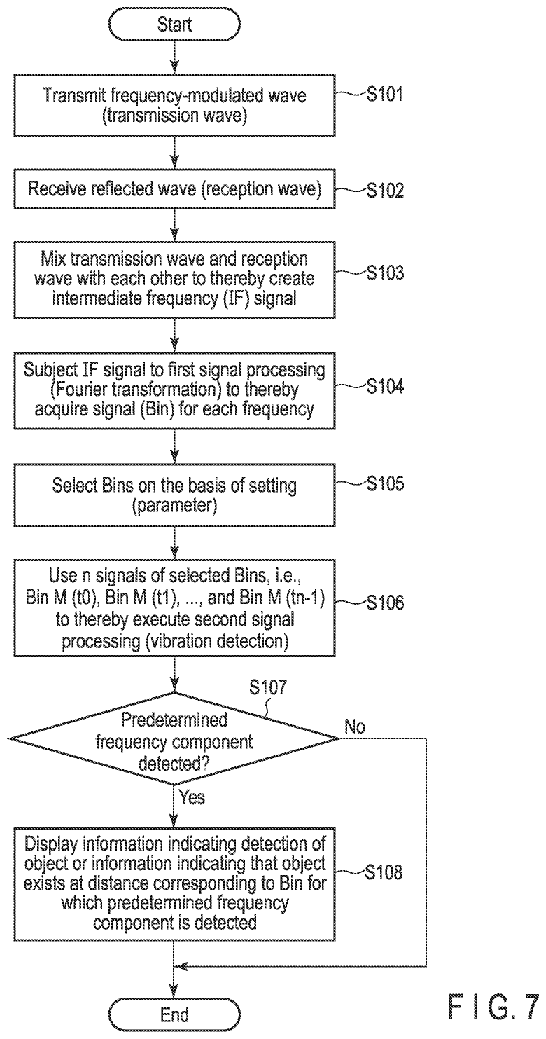

FIG. 7 is a flowchart showing an example of a processing procedure of the system 1 of this embodiment.

The system 1 transmits a frequency-modulated wave the frequency of which monotonically increases (or decreases) as a transmission wave (S101). The system 1 receives the reflected wave of the transmission wave transmitted in step S101 as a reception wave (S102). The system 1 mixes the transmission wave and reception wave with each other to thereby create an intermediate frequency (IF) signal (S103). The transmission wave in step S103 is not the bygone transmission wave transmitted in step S101, but is the latest transmission wave transmitted at the time of processing of step S103.

The system 1 subjects the IF signal created in step S103 to first signal processing (Fourier transformation) to thereby acquire a signal (Bin) for each frequency (S104). Based on the setting (parameter) carried out in advance, the system 1 selects Bins to be made the objects of the subsequent processing from among the Bins acquired in step S104 (S105).

The system 1 uses n signals of the same Bin M, i.e., Bin M (t0), Bin M (t1), . . . , and Bin M (tn-1) acquired from the n reception waves which are the reflected waves of the n transmission waves the transmission times of which are t0, t1, . . . , and tn-1, the n signals Bin M (t0), Bin M (t1), . . . , and Bin M (tn-1) being the X signals selected in step S105, i.e., Bin 1, Bin 2, . . . , Bin M, . . . , and Bin X to thereby execute second signal processing (vibration detection) (S106). The second signal processing is executed for each of the X Bins. The system 1 determines with respect to the detection results of step S106 whether or not the predetermined frequency component has been detected (S107). When the predetermined frequency component is detected (S107: Yes), the system 1 displays information indicating detection of the object or information indicating that an object exists at the distance corresponding to the Bin regarding which the predetermined frequency component is detected (S108).

As described above, in the system 1 of this embodiment, the radar 11 configured to transmit, from the antenna 12, an electric wave which propagates while spreading out in a conical shape, and reaches a wide range of area as compared with the laser light that linearly propagates while hardly spreading out is used, and thus it is possible, by only roughly directing the radar 11 to the direction of the electric wire, and electrically controlling the directivity thereof, to select the electric wire existing in the direction as a voltage detection object, and detect the vibration of the electric wire in the energized state. That is, the system 1 of this embodiment realizes noncontact voltage detection in which the device can be used based on unstable setting such as hand-holding, simplified mount or mobile object, e.g., a drone, and the object of voltage detection is automatically selected.

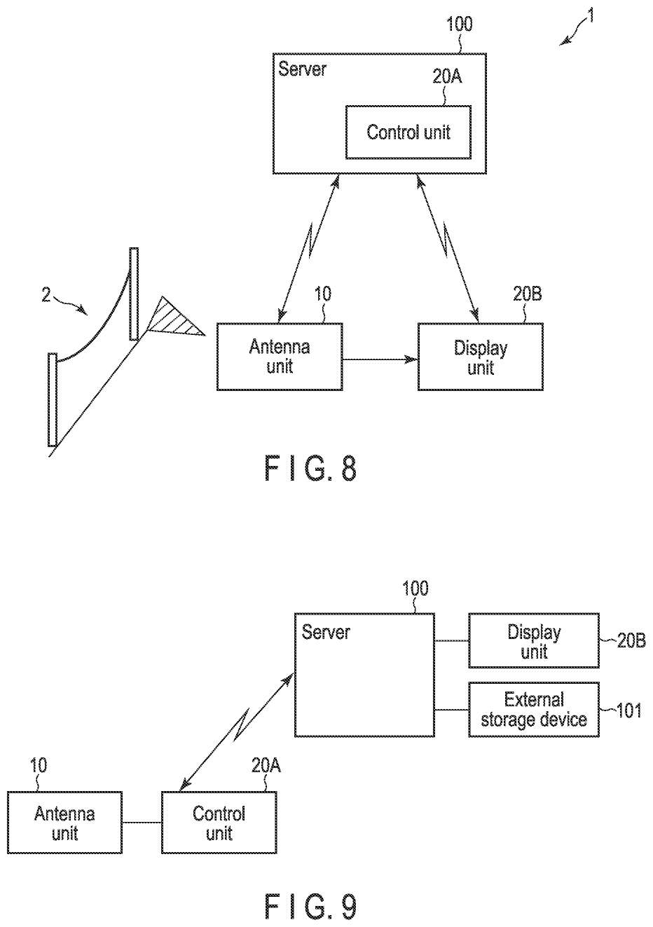

The system 1 of this embodiment can also be configured such that signal processing to be carried out for the purpose of detecting an electric wire in the energized state is executed in a unified manner at a distant place network-connected with the work-site. For example, as shown in FIG. 8, a control unit 20A configured to control an antenna unit 10 and display unit 20B may be constructed on a server 100 having a communication function. The control unit 20A makes the antenna unit 10 carry out transmission of a transmission wave and reception of a reception wave, uses the signal of the transmission wave and signal of the reception wave to thereby execute signal processing for detection of an electric wire in the energized state, and makes the display unit 20B display the detection result thereon. In the case of this configuration, it is possible to realize weight reduction and cost reduction of devices used at many work-sites scattered at many places (control/display unit 20→display unit 20B). In the case of this configuration too, the antenna unit 10 and display unit 20B may be accommodated in the same housing.

Further, as shown in, for example, FIG. 9, the antenna unit 10 and control unit 20A may be configured to output a detection result, and display unit 20B may be constructed on a server 100 having a communication function. The control unit 20A makes the antenna unit 10 carry out transmission of a transmission wave and reception of a reception wave, uses a signal of the transmission wave and signal of the reception wave to thereby execute signal processing for detection of an electric wire in the energized state, transmits a detection result to the server 100, and makes the display unit 20B display the detection result thereon. In the case of this configuration, the detection result received by the server 100 may immediately be displayed on the display unit 20B, and may temporarily be collected at an external storage device 101 connected to the server 100, and the totalized data may be displayed on the display unit 20B. Further, the totalized data may be displayed by a PC, smartphone or the like connected to the server 100. Examples of usage of this configuration include providing housings each of which accommodates therein an antenna unit 10 and control unit 20A respectively at positions in the vicinities of a plurality of electric wires which are the observation objects to thereby execute continuous monitoring of the energized state for each of the electric wires, mounting an antenna unit 10 and control unit 20A on a drone and, at the time of a periodic inspection or disaster, patrolling areas in which electric wires exist to thereby search for abnormal electric wires, and so on.

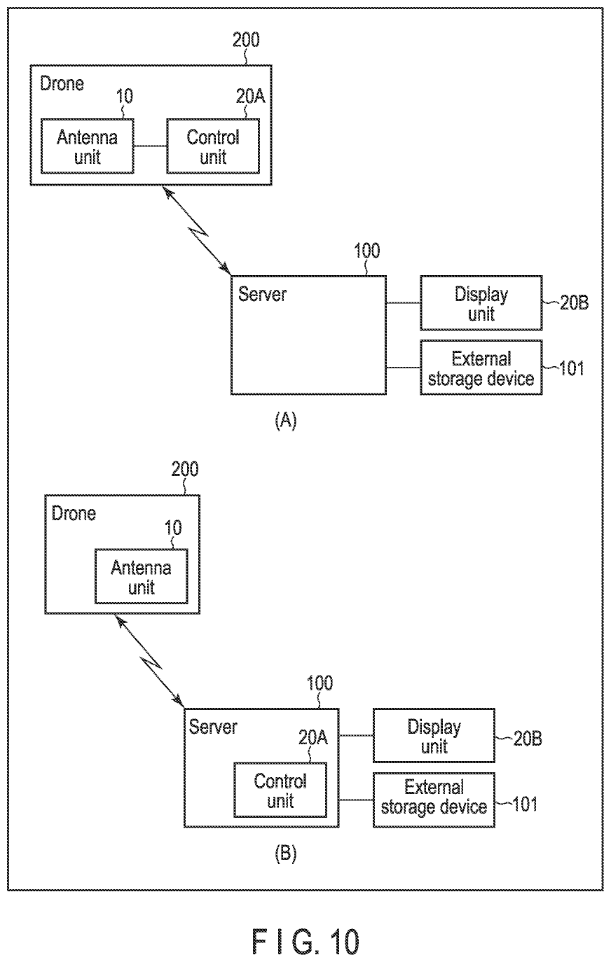

FIG. 10 is a diagram showing an example of the hardware configuration of the system 1 of this embodiment using a drone. FIG. 10(A) shows an example in which the antenna unit 10 and control unit 20A are mounted on a drone 200. Further, FIG. 10(B) shows an example in which the antenna unit 10 is mounted on the drone 200. For example, the drone 200 is made to take a flight over a mountainous area, thereby checking the electric wires (intermountain power-transmission-line patrol/inspection). At that time, the signal processing based on the reflected wave may be executed by a processor or the like incorporated in the drone 200 as in the case of the configuration shown in FIG. 10(A) or may be executed by the server 100 for signal processing communicating with the drone 200 as in the case of the configuration shown in FIG. 10(B).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A system comprising:
a radar including at least one first antenna and at least one second antenna, the at least one first antenna being configured to transmit a first transmission wave at a first time and transmit a second transmission wave at a second time different from the first time, the at least one second antenna being configured to receive reflected waves of the first transmission wave and the second transmission wave; and
a controller configured to detect an object in an energized state existing within a radiation range of the radar based on signals of the reflected waves.

2. The system of claim 1, wherein the controller is configured to create a frequency-modulated wave as a transmission wave of the radar, a frequency of the frequency-modulated wave monotonically increasing or decreasing.

3. The system of claim 1, further comprising a display configured to indicate a radiation direction of the radar or a radiation range of the radar.

4. The system of claim 1, wherein the controller is configured to input, as a parameter concerning detection of the object, at least one of a frequency of vibration occurring to the object in a case where the object is in the energized state, a frequency of an alternating current flowing through the object, a distance from the radar to the object, and a detection area in a transmission wave radiation range of the radar.

5. The system of claim 1, wherein:
a first reception wave and a second reception wave are received by the second antenna, the first reception wave and a second reception wave being made by synthesizing reflected waves of the first transmission wave and the second transmission wave from a plurality of objects in propagation space; and
the controller is configured to determine, when a first frequency component to be obtained from a difference between a set of a signal of the first reception wave and a signal of the second reception wave corresponded to each other based on a distance is greater than or equal to a threshold, that the object in the energized state exists in the radiation direction of the first antenna and at the distance on which the signal of the first reception wave and the signal of the second reception wave are corresponded to each other.

6. The system of claim 5, wherein the controller is configured to acquire the first frequency component by using one of Fourier transformation, correlation, band-pass filtering, frequency detection, and a resonance.

7. The system of claim 1, wherein the controller is configured to detect a plurality of objects in the energized state, when the plurality of objects in the energized state exist within the radiation range of the radar.

8. The system of claim 1, wherein the at least one first antenna and the at least one second antenna have directional properties different from each other.

9. The system of claim 1, wherein the at least one first antenna or the at least one second antenna is used as a phased array antenna.

10. The system of claim 3, wherein the display is configured to indicate a radiation direction or a radiation range of the radar by using a mark on a unit in which the at least one first antenna and the at least one second antenna are provided wherein the mark indicating the radiation direction or the radiation range of the radar.

11. The system of claim 3, wherein the display is configured to indicate a radiation direction or a radiation range of the radar by using an image shot by a camera provided on a unit in which the at least one first antenna and the at least one second antenna are provided such that the radiation direction of the radar and a shooting direction of the camera are coincident with each other.

12. A system comprising:
a communicator; and
a controller configured to:
transmit a signal of a first transmission wave and a signal of a second transmission wave to an external device via the communicator, the first transmission wave being a wave to be transmitted by at least one first antenna at a first time, the second transmission wave being a wave to be transmitted by the at least one first antenna at a second time different from the first time, the external device including the at least one first antenna and the at least one second antenna;
receive signals of reflected waves of the first transmission wave and the second transmission wave from the external device, the reflected waves being waves to be received by the at least one second antenna; and
detect an object in the energized state existing within the radiation range of the radar based on the signals of the reflected waves.

13. The system of claim 12, wherein the controller is configured to create a frequency-modulated wave as a transmission wave of the radar, a frequency of the frequency-modulated wave monotonically increasing or decreasing.

14. The system of claim 12, wherein the controller is configured to input, as a parameter concerning detection of the object, at least one of a frequency of vibration occurring to the object in a case where the object is in the energized state, a frequency of an alternating current flowing through the object, a distance from the radar to the object, and a detection area in a transmission wave radiation range of the radar.

15. The system of claim 12, wherein:
a first reception wave and a second reception wave are received by the second antenna, the first reception wave and a second reception wave being made by synthesizing reflected waves of the first transmission wave and the second transmission wave from a plurality of objects in propagation space; and
the controller is configured to determine, when a first frequency component to be obtained from a difference between a set of a signal of the first reception wave and a signal of the second reception wave corresponded to each other based on a distance is greater than or equal to a threshold, that the object in the energized state exists in the radiation direction of the first antenna and at the distance on which the signal of the first reception wave and the signal of the second reception wave are corresponded to each other.

16. The system of claim 15, wherein the controller is configured to acquire the first frequency component by using one of Fourier transformation, correlation, band-pass filtering, frequency detection, and a resonance.

17. A method of a system including a radar including at least one first antenna and at least one second antenna, the method comprising:
transmitting a first transmission wave at a first time by the at least one first antenna;
transmitting a second transmission wave at a second time different from the first time by the at least one first antenna;
receiving reflected waves of the first transmission wave and the second transmission wave by the at least one second antenna; and
detecting an object in the energized state existing within a radiation range of the radar based on signals of the reflected waves.

18. The method of claim 17, further comprising creating a frequency-modulated wave as a transmission wave of the radar, a frequency of the frequency-modulated wave monotonically increasing or decreasing.

19. The method of claim 17, further comprising inputting, as a parameter concerning detection of the object, at least one of a frequency of vibration occurring to the object in a case where the object is in the energized state, a frequency of an alternating current flowing through the object, a distance from the radar to the object, and a detection area in a transmission wave radiation range of the radar.

20. The method of claim 17, wherein:
a first reception wave and a second reception wave are received by the second antenna, the first reception wave and a second reception wave being made by synthesizing reflected waves of the first transmission wave and the second transmission wave from a plurality of objects in propagation space; and
the method further comprises determining, when a first frequency component to be obtained from a difference between a set of a signal of the first reception wave and a signal of the second reception wave corresponded to each other based on a distance is greater than or equal to a threshold, that the object in the energized state exists in the radiation direction of the first antenna and at the distance on which the signal of the first reception wave and the signal of the second reception wave are corresponded to each other.
